(19) United States
(12) Patent Application Publication
(10) Pub. No.: US 2020/0396982 A1
(43) Pub. Date: Dec. 24, 2020

(54) REUSABLE TRAY FOR A GLUE BOARD TRAP AND A TRAP HAVING SUCH A TRAY FITTED WITH A REPLACEABLE GLUE BOARD

(71) Applicant: WOODSTREAM CORPORATION, Lititz, PA (US)

(72) Inventors: Luke Benjamin HANEY, Lititz, PA (US); Allyssa Kelley-Brown, Marietta, PA (US)

(73) Assignee: WOODSTREAM CORPORATION, Lititz, PA (US)

(21) Appl. No.: 16/449,903

(22) Filed: Jun. 24, 2019

(51) Int. Cl. A01M 23/00; A01M 1/14

(52) U.S. Cl. CPC A01M 23/005; A01M 1/14

(57) ABSTRACT

A reuseable glue board tray to be fitted with a glue board to form a glue board trap for rodent and other pests, and a glue trap having a reusable glue board tray with refillable glue boards, are provided. The side walls of the tray have a slanted lip sloped at an angle of preferably about 45° to the horizontal with the low side of the slope being on the outside edge of the tray to encourage pest interaction with the glue board by eliminating barriers between the glue board and the surface on which the tray rests. In addition, at least one of the side walls does not have a lip to facilitate replacement of the glue board through the lipless side while further facilitating easy entry of pests. Finger access cutouts are provided in the side walls of the tray that allow the user to lift the tray without touching the glue board, and two opposing sides of the tray have inwardly extending tabs that lap over the adjacent outer edges of the glue board to prevent the board from falling out of the tray unintentionally. The configuration of the tabs and/or side walls enables a plurality of trays to be nested together to form a compact stack of trays.

### BACKGROUND OF THE INVENTION

### Field of the Invention

The present invention is related to the field of pest control and, more particularly, to glue board traps for rodents including mice, rats and voles, as well as snakes and insects.

### Description of the Related Art

Traps having an adhesive upper surface, generally referred to as glue traps, have been used for many years to catch pests. Being simple and relatively inexpensive in construction, a glue trap is typically designed for one-time use after which the trap is disposed of, along with the pest caught thereon.

Woodstream Corporation of Lititz, Pennsylvania, who is the assignee of the instant application, has developed a glue trap including a tray with a replaceable glue board that is commercially available in Canada as the M773CAN Victor® V Hold-Fast® Glue Tray. Disposing of only the glue board while reusing the same tray reduces waste and makes the glue traps more cost effective to use.

However, it has been found that in some cases the edges of the tray, which are elevated with respect to the upper surface of the glue board, can hinder pest interaction with the trap. In addition, the user may experience unwanted contact with the glue when replacing the board. Further, the glue board may inadvertently fall out of the tray and, if landing adhesive-side-down, the glue can become stuck to the floor.

Therefore it would be desirable to have a glue board trap operative with replaceable glue boards that overcomes the noted drawbacks that are sometimes encountered with refillable glue traps.

### SUMMARY OF THE INVENTION

In view of the foregoing, the present invention is directed to a reuseable tray into which a disposable glue board is inserted to form a glue board trap, and to a glue board trap having a reusable tray fitted with a replaceable glue board. The tray has opposed side walls provided with a slanted lip that is sloped downwardly at an angle of between about 15° and about 75° to the horizontal, preferably between about 35° and about 55°, and most preferably sloped at 45°, with the low side of the slope being on the outside edge of the tray. This slanted or sloped lip encourages pest interaction with the glue board by eliminating barriers between the glue board and the surface on which the tray rests. Use of the term “about” in connection with the angle of the slanted lip is intended to refer to the stated values plus or minus 10°. The side walls of the tray also preferably include finger access cutouts to allow the user to easily lift the tray without interacting with the glue board.

According to a preferred embodiment, the tray is made of injection molded plastic and has two longitudinal or long sides and two lateral or short sides that together define a substantially rectangular glue board platform. The long sides are preferably between about 9.5 inches and about 11.5 inches in length; the length of the short sides is preferably between about 3.5 inches and about 6 inches. Use of the term “about” in connection with the length of the sides is intended to refer to the stated values plus or minus 0.5 inches.

To facilitate replacement of the glue board, at least one of the short sides of the tray does not have a lip which makes it easy to slide the old board out and slide a new board onto the glue board platform. The lipless short side also provides for easy entry of pests. Alternatively, one of the long sides could be made lipless or all four sides of the tray could be of equal length in which case any side may be the side without a lip.

The glue board tray has a vertical height, as measured from the support surface upon which the trap is placed to the upper edge of the side walls, of between about 0.25 inches and about 0.50 inches. This vertical height keeps the glue board above the elements on the floor, such as water, dirt, etc., that can render the glue board ineffective. At the same time, the sloped lip on the side walls of the tray provides a low entry height for improved pest interaction. Use of the term “about” in connection with the height of the glue tray is intended to refer to the stated values plus or minus 0.1 inches.

To prevent the glue board from falling out of the tray unintentionally, the sides of the tray that extend transversely to the lipless side, preferably the long sides of the tray, include inwardly extending tabs that lap over the adjacent outer edges of the glue board. This overlap creates a longitudinally extending channel for receiving the outer opposed edges of the glue board to retain the board adjacent the upper surface of the bottom of the tray regardless of the orientation of the trap. As is known in the art, the outer opposed edges of the glue board are generally not adhesive so the glue board will not stick to the tabs. The lateral extent of the tab overlap is between about 2% and about 7% of the width of the tray. Use of the term “about” in connection with the lateral extent of the tab overlap is intended to refer to the stated values plus or minus 1%.

The tabs are vertically spaced above the upper surface of the tray bottom which forms the glue board platform so that a distance between the bottom surface of the tabs and the glue board platform is between about 0.035 inches and about 0.045 inches. Use of the term “about” in connection with the vertical spacing of the tabs is intended to refer to the stated values plus or minus 0.005 inches. Each long side may have one continuous tab that extends substantially the length of the tray or, preferably, a plurality of truncated tabs spaced longitudinally from one another to create the channel.

Accordingly, it is an object of the present invention to provide a reusable glue board tray that can be fitted with a disposable glue board to form a glue board trap, the side walls of the tray having a slanted lip, preferably sloped at an angle of about 45° to the horizontal, with the low side of the slope being on the outside edge of the tray to encourage pest interaction with the glue board by eliminating barriers between the glue board and the surface on which the tray rests.

Another object of the present invention is to provide a reusable glue board tray in accordance with the preceding object in which the side walls of the tray preferably include finger access cutouts to allow the user to lift the tray without interacting with the glue board.

Yet another object of the present invention is to provide a reusable glue board tray in accordance with at least one of the preceding objects in which the tray is made of injection molded plastic and has two long sides and two short sides, at least one of the short sides of the tray not having a lip to facilitate replacement of the glue board through the lipless side while also providing for easy entry of pests. A further object of the present invention is to provide a reusable glue board tray in accordance with the preceding objects in which the long sides are between about 9.5 inches and about 11.5 inches in length, the short sides are between about 3.5 inches and about 6 inches, and the vertical height of the tray is between about 0.25 inches and about 0.50 inches, creating a low height to surface area ratio that keeps the glue board above the elements on the floor and shielded therefrom by the barrier structure created by the side walls, while ensuring that pests can easily access the board from all sides.

A still further object of the present invention is to provide a reusable glue board tray in accordance with the preceding objects in which the long sides of the tray include inwardly extending tabs that lap over the adjacent outer edges of the glue board, the extent of the overlap being between about 2% and about 7% of the width of the tray, to secure the edges of the glue board and prevent the board from falling out of the tray unintentionally.

Yet a further object of the present invention is to provide a reusable glue board tray in accordance with at least one of the preceding objects in which the trays are nestable with one another, the present invention including a plurality of trays according to at least one of the preceding objects in which the trays are nested to form a compact stack for storage.

Another object of the present invention is to provide a glue board trap including a reusable glue board tray fitted with a replaceable glue board, the glue board tray including a generally rectangular tray floor and at least one pair of opposed side walls upwardly directed from the tray floor that together define a glue board platform, the opposed side walls including inwardly extending tabs that lap over adjacent outer edges of the glue board when the glue board is placed on the glue board platform, the tabs being vertically spaced above the glue board platform such that the overlap and the vertical spacing between the bottom surface of the tabs and the glue board platform create a longitudinally extending channel for receiving adjacent opposed outer edges of the glue board to retain the board on the glue board platform regardless of an orientation of the trap.

Yet another object of the present invention is to provide a glue board trap in accordance with the preceding object in which the tray floor is generally parallel with a support surface upon which the tray is placed, the at least one pair of opposed side walls having a slanted lip that is sloped at an angle of between about 15° and about 75° to an angle of the support surface, and preferably at 45°, with a low side of the slope being on an outside edge of the tray to encourage pest interaction with the glue board by eliminating barriers between the glue board and the support surface.

A further object of the present invention is to provide a glue board trap in accordance with the preceding two objects in which at least one side of the tray that extends transversely to the pair of opposed side walls is an open side that does not have a slanted lip, the open side facilitating replacement of the disposable glue board by enabling the disposable glue board to be positioned on the glue board platform through the open side.

Another object of the present invention is to provide a reusable glue board tray into which a disposable glue board is inserted to form a glue board trap, the tray including a generally rectangular tray floor having two longitudinal sides and two lateral sides that define a glue board platform, each of the longitudinal sides including at least one inwardly extending tab that laps over an adjacent outer edge of the glue board when the glue board is placed on the glue board platform, the tabs being vertically spaced above the glue board platform with the overlap and the vertical spacing creating a longitudinally extending channel for receiving adjacent outer edges of the glue board to retain the board on the glue board platform regardless of an orientation of the trap, the tabs having a sloped outer lip with a low side of the slope being on an outside edge of the tray to encourage pest interaction with the glue board, at least one of the lateral sides being an open side without tabs that facilitates replacement of the disposable glue board which is positioned on the glue board platform through the open side, the tray being nestable with other trays of the same type to form a compact stack of trays.

Yet another object of the present invention is to provide a reusable glue board tray in accordance with the preceding object in which a plurality of such trays are nested with one another to form a compact stack of trays for at least one of storage and sale. Still another object of the present invention is to provide a reusable glue board tray and a glue board trap having such a tray in accordance with any of the preceding objects that can be readily manufactured using known techniques, is easy to handle, and is durable, reliable and cost effective in use. These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is an exploded top view of the reuseable tray and glue board components of a mouse glue board trap in accordance with the present invention.

FIG. 2 is a side view of the trap components shown in FIG. 1.

FIG. 3 is a perspective view of the trap components shown in FIG. 1.

FIG. 4 is a perspective view of the trap components shown in FIG. 3 showing the glue board being inserted through the open side of the tray in the direction of the arrow.

FIG. 5 is an assembled view of the trap components shown in FIG. 1 to form the mouse glue board trap according to the present invention.

FIG. 6 is a top view of the trap shown in FIG. 5 and rotated 180 degrees.

FIG. 7 is a side view of the trap shown in FIG. 6. FIG. 7A is a sectional view taken along line A-A of FIG. 7.

FIG. 7B is an enlarged view of Detail B of FIG. 7A.

FIG. 7C shows the tab of FIG. 7B without a glue board inserted in the channel.

FIG. 8 is a perspective view of a plurality of reuseable mouse trap trays in a nested configuration in accordance with the present invention.

FIG. 9 is a side view of the nested trays shown in FIG. 8.

FIG. 9A is a sectional view taken along line A-A of FIG. 9.

FIG. 9B is an enlarged view of Detail B of FIG. 9A.

FIG. 10 is an exploded top view of the reuseable tray and glue board components of a rat glue board trap in accordance with the present invention.

FIG. 11 is a perspective view of the trap components shown in FIG. 10.

FIG. 12 is a perspective view of the trap components shown in FIG. 11 showing the glue board being inserted through the open side of the tray in the direction of the arrow.

FIG. 13 is an assembled view of the trap components shown in FIG. 10 to form the rat glue board trap according to the present invention.

FIG. 14 is a side view of the tray shown in FIG. 10.

FIG. 14A is a sectional view taken along line A-A of FIG. 14.

FIG. 14B is an enlarged view of Detail B of FIG. 14A.

FIG. 15 is a perspective view of a plurality of reuseable rat trap trays in a nested configuration in accordance with the present invention.

FIG. 16 is a side view of the nested trays shown in FIG. 15.

FIG. 16A is a sectional view taken along line A-A of FIG. 16.

FIG. 16B is an enlarged view of Detail B of FIG. 16A.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

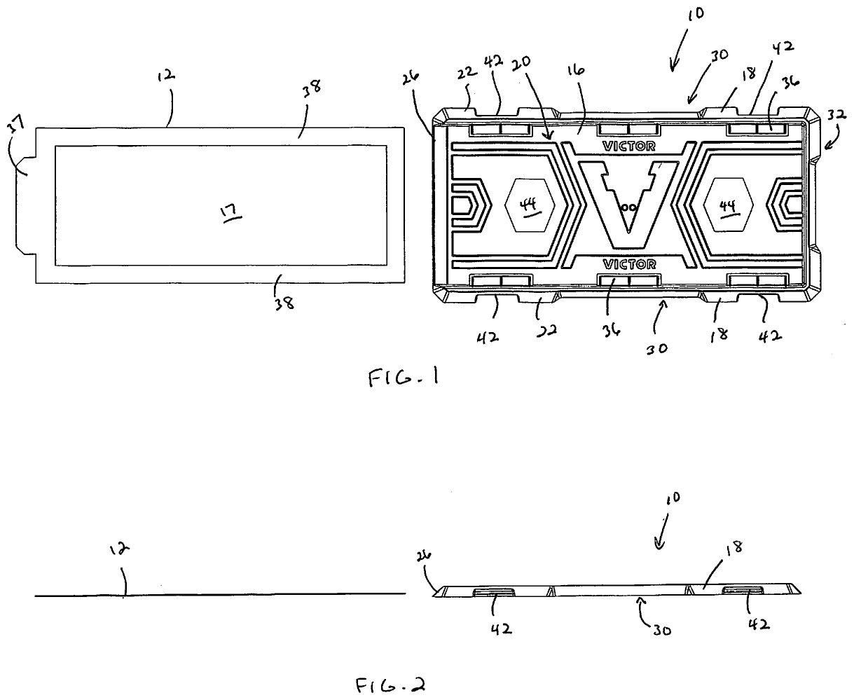

As shown in FIGS. 1-9B, the present invention is directed to a reuseable mouse glue board tray generally designated by reference numeral 10 into which a disposable glue board 12 is inserted as shown in FIG. 4 to form a glue board mouse trap generally designated by reference numeral 14 and shown as assembled in FIGS. 5-7. The reuseable tray 10 includes a generally rectangular tray floor 16 and at least one pair of upwardly directed opposed side walls 18 that together define a glue board platform generally designated by reference numeral 20.

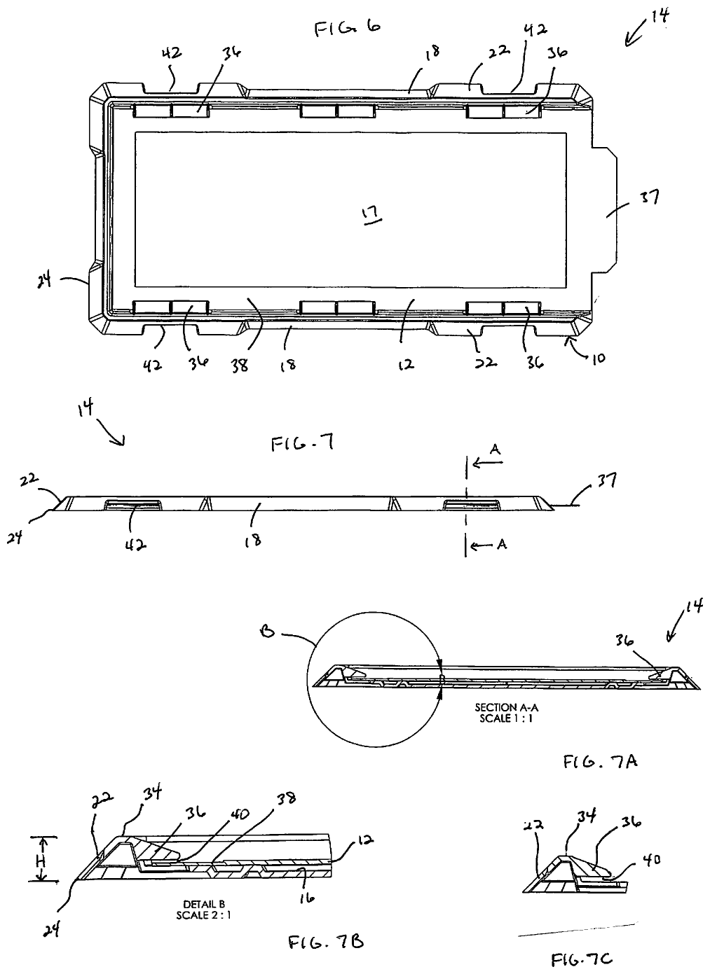

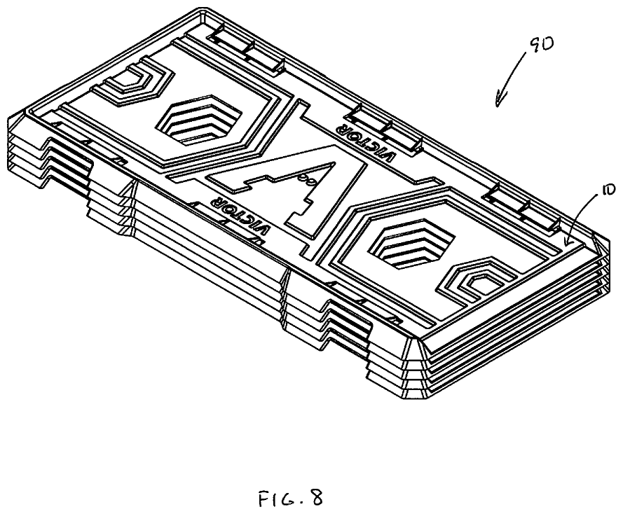

The tray floor 16 is substantially planar and is generally parallel with the support surface, typically horizontal, upon which the tray is placed. The at least one pair of opposed side walls 18 have an outwardly slanted lip 22, best shown in FIG. 7B, that is sloped at an angle of between about 15° and about 75° to the horizontal, preferably between about 35° and about 55°, and most preferably sloped at 45° to the angle of the support surface. The low side of the slope is on the outside edge 24 of the tray (see FIGS. 2, 7, 7A and 7B) to encourage pest interaction with the glue board by eliminating barriers between the glue board and the support surface.

At least one side of the tray that extends transversely to the pair of opposed side walls does not have a slanted lip and is referred to herein as the open side 26. The open side 26 facilitates replacement of the disposable glue board 12, with the disposable glue board 12 being positioned on the glue board platform through the open side as will be further described hereinafter.

According to a preferred embodiment, the tray has two longitudinal or long sides generally designated by reference numeral 30 and two lateral or short sides generally designated by reference numeral 32. The opposed side walls 18 are on the long sides 30, while the open side 26 is on one of the short sides 32. If desired, both short sides 32 may be formed without a lip. The long sides are preferably between about 9.5 inches and about 10.5 inches in length; the length of the short sides is preferably between about 3.5 inches and about 5 inches.

The vertical height H of the glue tray (see FIG. 7B), as measured from the support surface upon which the trap is placed to the upper edge 34 of the side walls, is between about 0.25 inches and about 0.50 inches. This vertical height keeps the glue board above the elements on the floor, such as water, dirt, etc., that can render the glue board ineffective. Protection against dirt and debris or other environmental contaminants on the floor encroaching onto the glue board is further provided by the side walls themselves which serve as a protective barrier around at least two, and preferably three, sides of the glue board. At the same time, the sloped lip 22 on the side walls 18 of the tray 10 provides a low entry height for improved pest interaction.

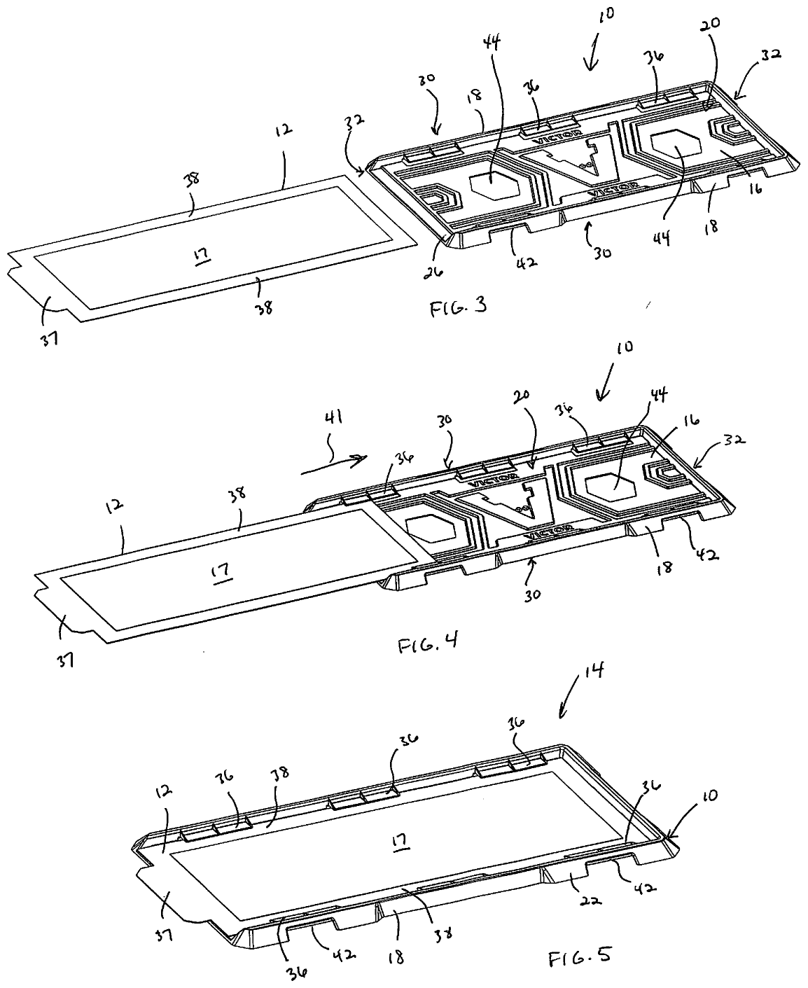

To prevent the glue board 12 from falling out of the tray 10 unintentionally, the long sides 30 of the tray include inwardly extending tabs 36 (see FIGS. 3-6, 7A and 7B) that lap over the adjacent outer edges 38 of the glue board 12 as shown in FIGS. 5, 6, 7A and 7B. The lateral extent of the tab overlap is between about 2% and about 7% of the width of the tray. The tabs 36 are vertically spaced above the glue board platform 20 so that the bottom surface of the tabs is between about 0.035 inches and about 0.045 inches above the platform. This spacing, in conjunction with the overlap, creates a longitudinally extending channel 40 (see FIG. 7C) for receiving the outer edges 38 of the glue board 12 (see FIGS. 4-6, 7A and 7B) to retain the board on the glue board platform 20 regardless of the orientation of the trap, i.e., even if the trap is turned upside down.

Each long side 30 may have one continuous tab that extends substantially the length of the tray or, preferably, a plurality of truncated tabs may be spaced longitudinally from one another to create the channel 40 as shown in FIGS. 3-6. Further, while the tray has been described with the open side being one of the short sides, alternatively, one of the long sides could be made lipless or all four sides of the tray could be of equal length in which case any side may be the side without a lip. Regardless of which side is the open side, the sides of the trap that extend transversely to the lipless side are the sides that are provided with the opposed walls 18 and tabs 36 for securing the glue board on the platform 20.

As shown in FIGS. 1-7, the side walls 18 of the tray preferably include finger access cutouts 42 to allow the user to easily lift the tray without interacting with the glue board. The platform 20 also has cutouts 44 to allow finger access to the underside of the glue board to enable the user to push the board up and out from under the tabs 36 that hold the board against the tray when changing boards.

The placement of a glue board 12 onto the glue board platform 20 of the tray 10 is shown in FIG. 4. The board 12 is aligned with the tray as shown in FIG. 3 and then inserted into the channel 40 and moved in the direction of the arrow 41 to mount the board to form the trap 14 as shown in FIG. 5. The outer opposed edges 38 which surround the adhesive area 17 of the glue board 12 are generally not adhesive so the glue board will not stick to the tabs 36. In addition, the glue board may include a tab handle 37 with which the user can grasp the board to assist in placement of the board as well as for sliding out and/or pulling up on the board for removal thereof from the tray.

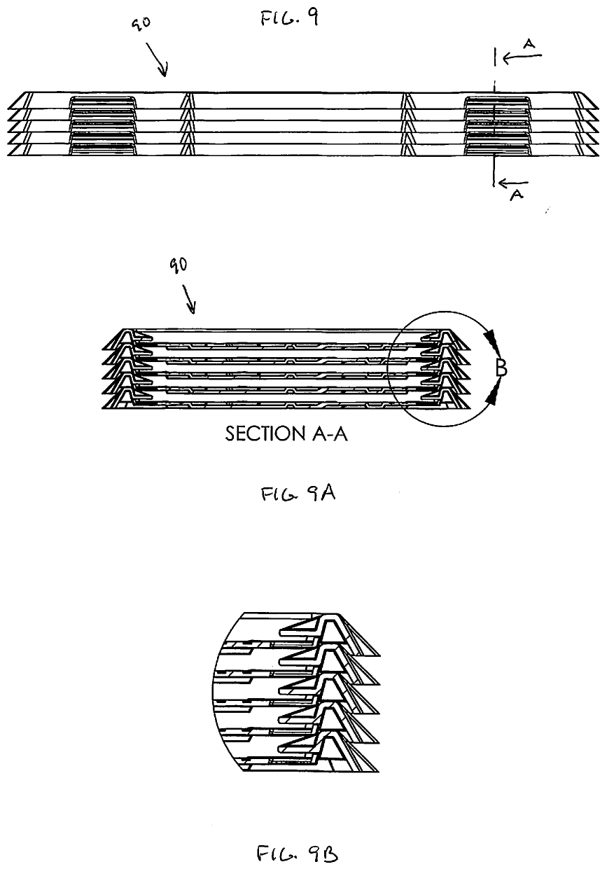

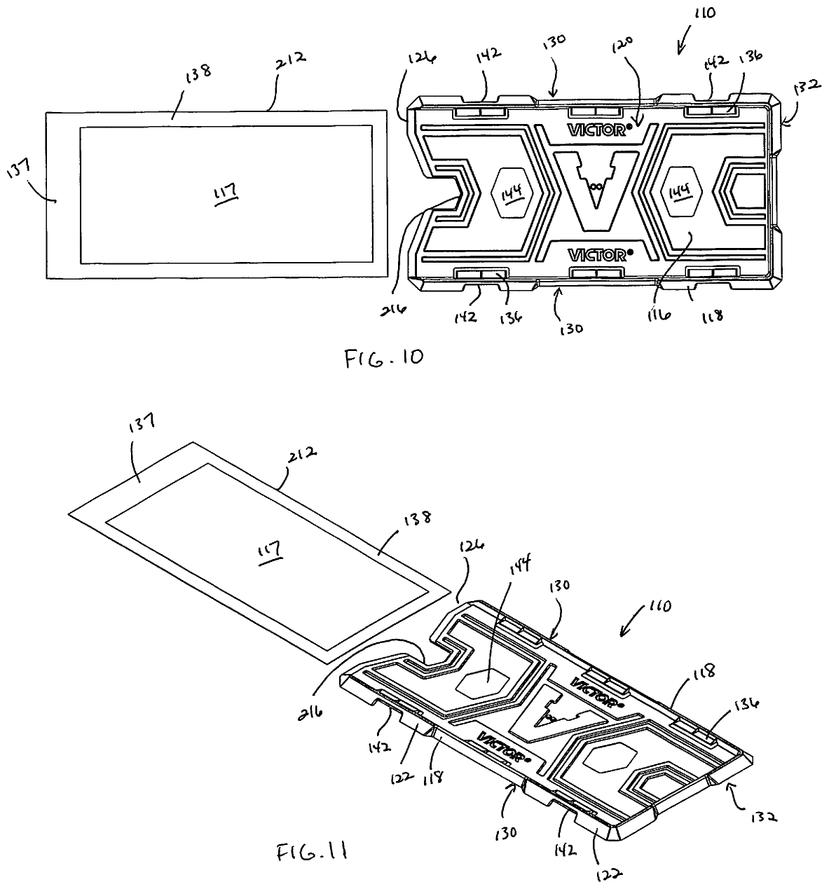

The trays 10 are nestable so that a plurality of trays may be stacked together to form a compact stack of trays generally designated by reference numeral 90 as shown in FIGS. 8, 9, 9A and 9B. Nesting of the trays reduces storage space requirements both during marketing and retail sale as well as for the consumer prior to deployment and use of the trays. The present invention therefore includes a nestable tray and a plurality of such trays in a nested relationship to form a compact stack of trays for at least one of storage and sale.

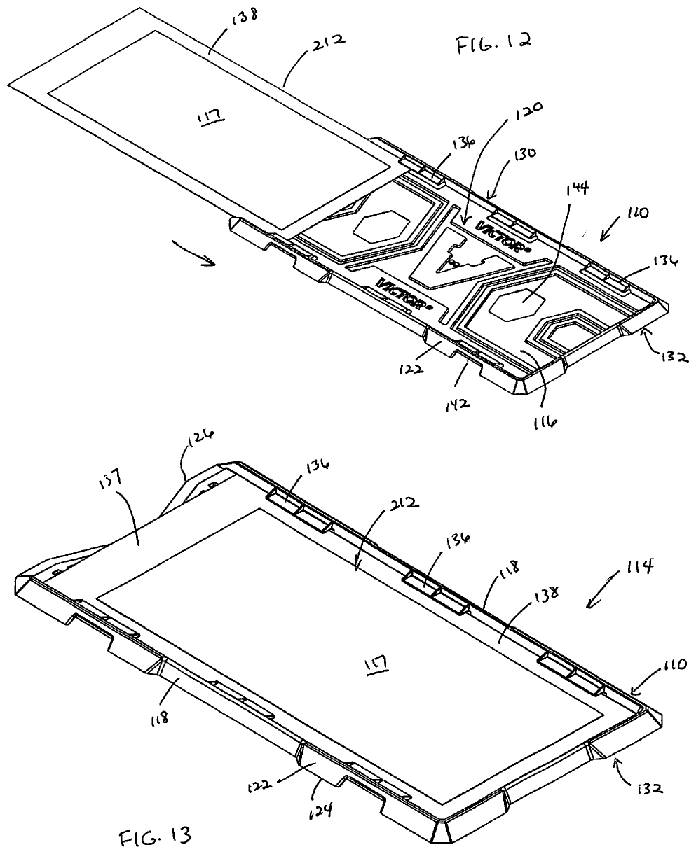

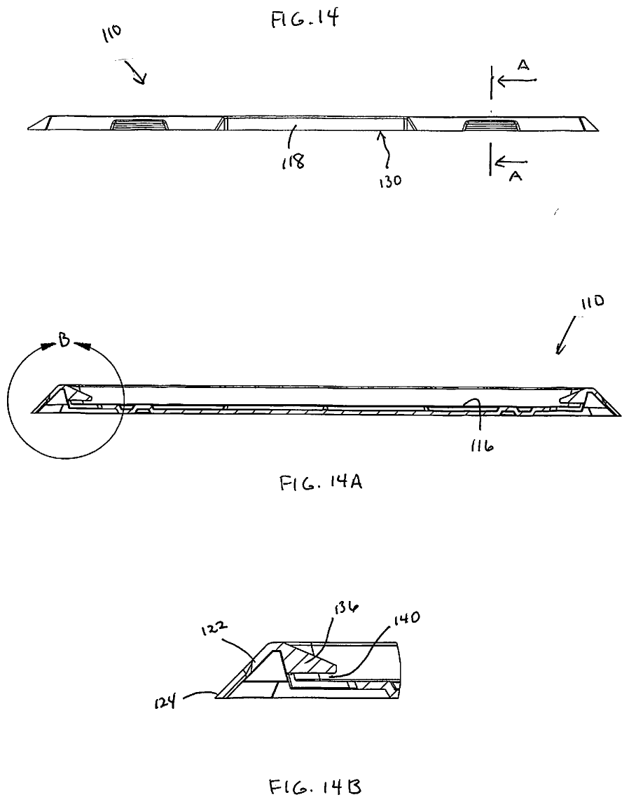

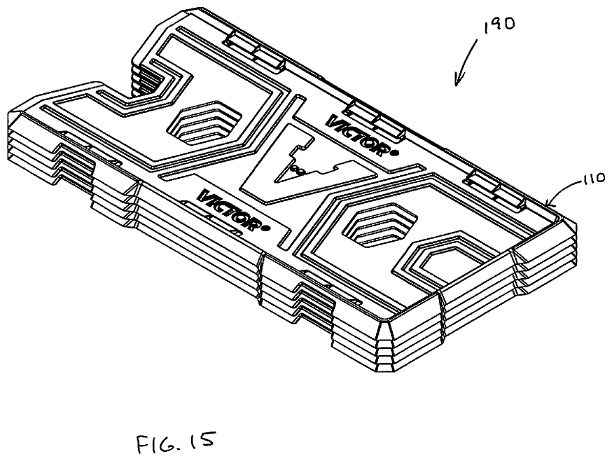

FIGS. 10-16B show a reuseable glue board tray, generally designated by reference numeral 110, into which a disposable glue board 212 is inserted as shown in FIG. 12 to form a glue board rat trap generally designated by reference numeral 114 and shown in FIG. 13. The glue board tray 110 for the rat trap 114 has many comparable features to those already described in connection with the glue board mouse trap. These features are identified with corresponding reference numerals to which a prefix numeral “1” has been added with the understanding that the structures operate in like manner to those already described in connection with the mouse trap. Therefore, to avoid redundancy, only the differences with respect to the mouse glue board trap 14 will be discussed hereinafter.

Unlike with the mouse glue board tray 10, the open side 126 of the glue board tray 110 of the rat trap 114 includes a cutout or recess 216 in the platform 116 to enable the user to more easily grasp the end 137 of the glue board for removal thereof. With this recess 216, the glue board does not need to include the projecting tab handle which is shown in connection with the mouse glue board of FIGS. 1-7.

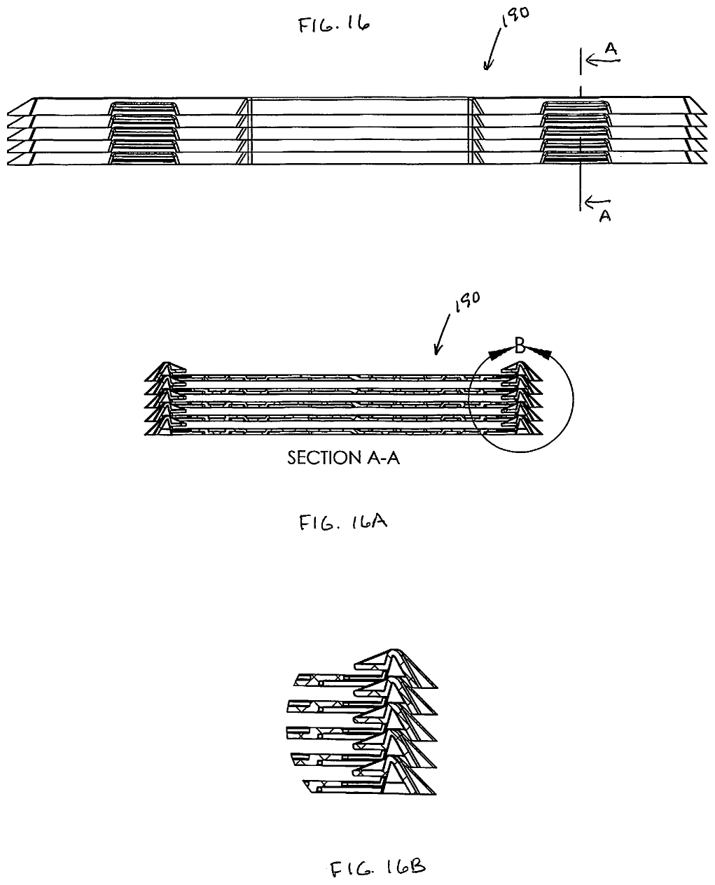

The long sides 130 of the rat tray 110 are preferably between about 9.5 inches and about 11.5 inches in length; the length of the short sides 132 is preferably between about 4.5 inches and about 6 inches. Like the mouse glue board trays 10, the rat glue board trays 110 are also nestable to form a compact stack of trays 190 as shown in FIGS. 15, 16, 16A and 16B, with the present invention including such a stack of two or more nested trays.

According to the embodiments shown herein, the trays 10, 110 are made of injection molded plastic of any kind known by persons of skill in the art to be suitable for rodent trap products of the type described herein. The glue boards 12, 112 are of conventional construction and are mounted on the trays 10, 110 by sliding the board into the channel 40, 140 through the open side 26, 126 of the tray 10, 110.

As described herein, the reusable trays with sloped side walls facilitate pest interaction with the trap while the open side allows for easy replacement of the glue board to provide a cost-effective glue trap construction. The tabs prevent the glue board from inadvertently falling out of the tray, and the finger access cutouts prevent the user from unwanted contact with the glue when replacing the board.

While not preferred, the reusable trays may be made with the side walls being nearly flush with the platform and only the tabs extending upwardly and preferably including the outward slant to form a sloped lip. With this configuration, the tabs may be used to nest a plurality of trays together in like manner as with the two tray embodiments set forth in detail herein. This alternative construction with nearly flush side walls is less desirable, however, as the barrier function of the upwardly directed opposed side walls against unwanted environmental contaminants adhering to the glue board is effectively lost, along with the ability to easily pick up the tray using the preferred finger cutouts in the opposed side walls.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A reuseable glue board tray into which a disposable glue board is inserted to form a glue board trap, said reuseable glue board tray comprising:
a generally rectangular tray floor and at least one pair of opposed side walls upwardly directed from the tray floor that together define a glue board platform, the tray floor being generally parallel with a support surface upon which the tray is placed, said at least one pair of upwardly directed opposed side walls having a slanted lip that is sloped at an angle of between about 30° and about 50° to an angle of the support surface, a low side of the slope being on an outside edge of the tray to encourage pest interaction with the glue board by eliminating barriers between the glue board and the support surface, at least one side of the tray that extends transversely to the pair of opposed side walls being an open side that does not have a slanted lip, said open side facilitating replacement of the disposable glue board, said disposable glue board being positioned on the glue board platform through said open side.

2. The reuseable glue board tray according to claim 1, wherein a side of the tray opposite the open side includes a side wall with a slanted lip sloped at an angle of between about 15° and about 75° to the angle of the support surface, a low side of the slope being on the outside edge of the tray.

3. The reuseable glue board tray according to claim 2, wherein the angle of the support surface is horizontal and the slanted lips on said side walls are sloped at an angle of about 45° to the horizontal.

4. The reuseable glue board tray according to claim 1, wherein the at least one pair of opposed side walls include finger access cutouts to allow the user to lift the tray without interacting with the glue board.

5. The reuseable glue board tray according to claim 1, wherein the tray is made of injection molded plastic and has two longitudinal sides and two lateral sides, said longitudinal sides including the at least one pair of opposed side walls and being longer than said lateral sides, said trap having a vertical height, as measured from the support surface to an upper edge of the opposed side walls, of between about 0.25 inches and about 0.50 inches.

6. The reuseable glue board tray according to claim 5, wherein the longitudinal sides are between about 9.5 inches and about 11.5 inches in length, and the lateral sides are between about 3.5 inches and about 6 inches in length.

7. The reuseable glue board tray according to claim 5, wherein said at least one pair of opposed side walls include inwardly extending tabs that lap over adjacent outer edges of the glue board when said glue board is placed on the glue board platform, said tabs being vertically spaced above the glue board platform, said overlap and said vertical spacing creating a longitudinally extending channel for receiving adjacent outer edges of the glue board to retain the board on the glue board platform regardless of an orientation of the trap.

8. The reuseable glue board tray according to claim 7, wherein the vertical spacing of the tabs is between about 0.035 inches and about 0.045 inches above the glue board platform and a lateral extent of the tab overlap is between about 2% and about 7% of a width of the tray.

9. The reuseable glue board tray according to claim 1, wherein the trays are nestable, a plurality of trays being nested with one another to form a compact stack of trays.

10. A glue trap comprising a reuseable glue board tray fitted with a separately disposable glue board, the glue board tray including a generally rectangular tray floor and at least one pair of opposed side walls upwardly directed from the tray floor that together define a glue board platform, said opposed side walls including inwardly extending tabs that lap over adjacent outer edges of the glue board when said glue board is placed on the glue board platform, said tabs being vertically spaced above the glue board platform, said overlap and said vertical spacing creating a longitudinally extending channel for receiving adjacent outer edges of the glue board to retain the board on the glue board platform regardless of an orientation of the trap.

11. The glue trap as set forth in claim 10, wherein the tray floor is generally parallel with a support surface upon which the tray is placed, said at least one pair of opposed side walls having a slanted lip that is sloped at an angle of between about 15° and about 75° to an angle of the support surface, a low side of the slope being on an outside edge of the tray to encourage pest interaction with the glue board by eliminating barriers between the glue board and the support surface.

12. The glue trap as set forth in claim 11, wherein at least one side of the tray that extends transversely to the pair of opposed side walls is an open side that does not have a slanted lip, said open side facilitating replacement of the disposable glue board, said disposable glue board being positioned on the glue board platform through said open side.

13. The glue trap according to claim 12, wherein the vertical spacing of the tabs is between about 0.035 inches and about 0.045 inches above the glue board platform.

14. The glue trap according to claim 13, wherein a lateral extent of the tab overlap is between about 2% and about 7% of a width of the tray.

15. The glue trap according to claim 12, wherein a side of the tray opposite the open side includes a side wall with a slanted lip sloped at an angle of between about 15° and about 75° to the angle of the support surface, a low side of the slope being on the outside edge of the tray.

16. The glue trap according to claim 10, wherein the at least one pair of opposed side walls include finger access cutouts to allow the user to lift the tray without interacting with the glue board.

17. The glue trap according to claim 10, wherein the tray is made of injection molded plastic and has two longitudinal sides and two lateral sides, said longitudinal sides including the at least one pair of opposed side walls and being longer than said lateral sides, said trap having a vertical height, as measured from the support surface to an upper edge of the opposed side walls, of between about 0.25 inches and about 0.50 inches.

18. The glue trap according to claim 17, wherein the longitudinal sides are between about 9.5 inches and about 11.5 inches in length, and the lateral sides are between about 3.5 inches and about 6 inches in length.

19. The glue trap according to claim 10, wherein the trays are nestable with one another, a plurality of said trays being nested to form a compact stack of trays.

20. A reuseable glue board tray into which a disposable glue board is inserted to form a glue board trap, said reuseable glue board tray comprising a generally rectangular tray floor having two longitudinal sides and two lateral sides that define a glue board platform, each of said longitudinal sides including at least one inwardly extending tab that laps over an adjacent outer edge of the glue board when said glue board is placed on the glue board platform, said tabs being vertically spaced above the glue board platform, said overlap and said vertical spacing creating a longitudinally extending channel for receiving adjacent outer edges of the glue board to retain the board on the glue board platform regardless of an orientation of the trap, said tabs having a sloped outer lip with a low side of the slope being on an outside edge of the tray to encourage pest interaction with the glue board, at least one of said lateral sides being an open side without tabs, said open side facilitating replacement of the disposable glue board which is positioned on the glue board platform through said open side, said tray being nested with at least one other tray of the same type to form a compact stack of trays.
